(19) United States
(12) Patent Application Publication
(10) Pub. No.: US 2013/0075672 A1
(43) Pub. Date: Mar. 28, 2013

(54) Kit for preparing a conductive pattern

(71) Applicant: Simona Magdalena Rucareanu, Brussels (BE)

(72) Inventor: Simona Magdalena Rucareanu, Brussels (BE)

(21) Appl. No.: 13/121,333

(22) PCT Filed: Sep. 28, 2009
(86) PCT No.: PCT/NL09/50577

§ 371 Date: Jun. 8, 2012

(30) Foreign Application Priority Data
Sep. 29, 2008 (EP) 08165416.2

(51) Int. Cl. C09D 11/00; B65D 25/00

(52) U.S. Cl. CPC C09D 11/52; B65D 25/00; Y10S 977/773; Y10S 977/81; B82Y 30/00
USPC 252/514; 252/519.21; 206/223; 427/126.1; 427/535; 427/532; 977/773; 977/810

(57) ABSTRACT

The invention relates to a kit for preparing a conductive element comprising a container A containing a liquid dispersion A′, comprising dispersed nanoparticles having a metallic surface and a ligand capable of binding to said surface; a container B—which may be the same or different as the container A containing the liquid dispersion A′—said container B containing a liquid B′ comprising reducible silver ions or other reducible metal ions; and a further container C containing a liquid C′ comprising a reducing agent for the metal ions of the liquid from container B.

### FIELD OF THE INVENTION

The invention relates to a kit for preparing a conductive element. The invention further relates to a method of preparing such pattern, image or layer. The invention further relates to nanoparticles, which may be used as part of a kit of the invention.

### BACKGROUND OF THE INVENTION

Conductive inks can be used to print a conductive pattern on a substrate, e.g. in the manufacture of electronic circuits. Conventional inks based on metal particles require a sintering step at elevated temperature (e.g. of 150-300° C.), which limits the use thereof to printing on substrates that can withstand such substrates. Flexible electronics on polymeric substrates, for example, are often incompatible with thermal sintering above 100-150° C. Furthermore, heating to sintering temperature costs energy. Accordingly, there is an increasing demand for conductive inks sinterable under ambient conditions.

WO 03/038002 describes a method for ink jet printing onto a substrate, comprising printing a flocculant-containing liquid on top of a first printed ink layer. According to this method, the conductivity of a printed layer can be increased via flocculation rather than sintering of metallic particles; flocculation can be performed at lower temperatures than those common for sintering. However, the content of metal in the ink jet composition is rather low (0.1-1.44 wt. % nanoparticles), which limits the amount of metal that can be printed in a deposition run. Accordingly, multiple deposition runs need to be carried out, or use needs to be made of other deposition processes that use the first printed metal pattern as a template for the formation of additional metal layers (e.g. an ‘electroless’ deposition process).

In addition, WO 03/038002 describes an ink jet composition consisting essentially of a water-based dispersion consisting essentially of metal nanoparticles and at least one water-soluble polymer. The polymer is used to stabilise the dispersion of the particles. It is contemplated that the presence of a polymer or other large compound in the solution may be disadvantageous, e.g. in that it may adversely interfere with the deposition of metal and/or may adversely affect the conductivity of the coated layer and/or may cause defects in the layer that may detrimentally affect a mechanical property.

Another report of polymer-containing nanoparticle dispersions is found in WO2006/076611, describing ink compositions based on metal nanoparticles (preferably silver) stabilized with polymers (polyols). The sintering of the particles (‘curing’) occurs at a temperature of 100° C. However, this temperature is lower than the temperature at which decomposition/volatilization of the polymers occurs. It is likely that in such a case only a fraction of the polymers is removed; the remaining part is trapped in the pattern, increasing its porosity and limiting its conductivity.

Thus, one should be aware that once it has been possible to apply a lower sintering temperature, other problems such as poor removal of additives can occur.

It is the inventors' finding that the tendency of nanoparticles with a metallic surface to agglomerate (and thereby destabilise the dispersion), increases with decreasing particle size (especially for particles having a size of less than about 100 nm), in particular at a relatively high concentration in the dispersion. As a consequence, synthesis, handling and storage of such nanoparticles are complicated. A stabilising agent such as a polymer may be effective to stabilise dispersions having a relatively low concentration of metallic nanoparticles for some time. However, it is the inventors' finding that the effectivity of a polymer may be insufficient for stabilising concentrated dispersions of metallic nanoparticles, especially when the particles are small. It was in particular found that the effectivity of a polymer may be insufficient if the polymer is to be used in a concentration that is not likely to give cause to other problems (such as the need for a high sintering temperature as described above). In addition, it appeared that commercially available inks based on polymer-stabilized silver nanoparticles form a solid deposit upon storage, also indicating insufficient stabilization of metal (silver) nanoparticles.

WO 2004/005413 describes a method wherein metal nano-powders are mixed in a solvent and one or more further ingredients, such as a binder, a polymer and/or a surfactant. After applying the mixture to a surface to be coated the solvent is evaporated and thereafter the coated layer is sintered at a temperature of 50-300° C. A sintering step is required. Optionally, the nano-powder is admixed with a reagent (a metal colloid, a metal reducible salt, an organic metal complex, an organo-metal compound) that is decomposed to form conductive materials. As indicated above, the presence of a polymer may be disadvantageous. In addition, in case the powder is to be involved in a reaction to form a conductive material, the presence of ingredients such as polymers or the like may hamper the access of the reagent to the surface of the powder, which may detrimentally affect the reaction rate and/or the final conversion.

WO 2006/014861 describes a method of forming a patterned conductive metal phase on a receiver by depositing a reducible metal salt, a reduction catalyst and a reducing agent, wherein at least the metal salt is deposited more than one time. The reduction catalyst is typically a pre-formed metal cluster, in particular Carey Lea Silver dispersion (CLS), which comprises gelatine. The presence of gelatine may be detrimental to the printing process, for the reasons given above when discussing the drawback of the presence of polymers. Further, CLS is not liquid at room temperature (25° C.), thus it can only be used above room temperature. The need to apply one or more of the components multiple times is a disadvantage, in view of processing speed. Further, according to the example, the obtained pattern is very dark black, which is an indication that substantial amounts of the silver ions have not been reduced and/or that non-conductive by-products have been formed.

It is an object of the invention to provide a novel product comprising a dispersion of nanoparticles having a metallic surface, suitable for preparing a conductive element, such as an electrically conductive connection between individual contacts of electronic components, e.g. in an electronic device, such as a shunt line or a bus bar for an OLED-based lighting or signage device.

A particular object of the invention is to provide such a product which overcomes one or more of the above drawbacks.

A particular object of the invention is to provide such a product, which has a good storage stability. With storage stability is in particular meant the period during which the dispersion can be stored at 25° C. (in the dark) while it remains usable for preparing a conductive pattern.

It is a further object to provide a novel method for preparing a conductive element, in particular a method which does not require a sintering step or which allows effective sintering at a moderate temperature, e.g. of less than 150° C. In particular, it is an object of the invention to provide a method that can be carried out without having to subject a printed or sprayed element to a heat treatment in excess of 75° C., more in particular in excess of 50° C. or in excess of 25° C.

It is in particular an object to provide a method that allows the preparation of a conductive element with satisfactory properties wherein the components of the product only need to be applied once, if desired.

### SUMMARY OF THE INVENTION

One or more objects which may be met will follow from the description and/or the claims below.

It has now been found possible to provide a product in the form of a kit comprising a liquid dispersion with nanoparticles stabilised in a specific manner, the kit further comprising reducible metal ions and a reducing agent.

Accordingly, the present invention relates to a kit for preparing a conductive element comprising
a container A containing a liquid dispersion A′, comprising dispersed nanoparticles having a metallic surface and a ligand capable of binding to said surface;
a container B—which may be the same or different as the container A containing the liquid dispersion A′—said container B containing a liquid B′ comprising reducible silver ions or other reducible metal ions; and
a further container C containing a liquid C′ comprising a reducing agent for the metal ions of the liquid from container B.

Said containers can be individual containers (separable from each other, e.g. different bottles) or be integrated in a single holder, such as a cartridge, e.g. for a printer.

The invention further relates to a liquid dispersion A′, comprising dispersed nanoparticles having a metallic surface and a ligand capable of binding to said surface.

The invention further relates to nanoparticles comprising a silver alloy or a gold alloy, in particular an alloy of gold and silver, of which particles the surfaces have been provided with a ligand selected from the group of quaternary ammonium compounds, in particular a quaternary ammonium compound as described in further detail herein below.

The invention further relates to a method for preparing a conductive element, comprising applying
a liquid dispersion A′, comprising dispersed nanoparticles having a metallic surface to which surface a ligand is bound;
a liquid B′ comprising a reducible silver ion or another reducible metal ion; and
a liquid C′ comprising a reducing agent for the metal ions, to a substrate and reducing the reducible salt, under formation of the conductive element.

The invention further relates to a product comprising a conductive element obtainable by a method according to the invention.

### BRIEF DESCRIPTION OF THE DRAWINGS

FIG. 1 displays the UV-VIS spectra of different compositions of Ag/Au tetraoctylammonium bromide (TOAB) nanoparticles; the compositions differ in the Ag/Au/TOAB ratios, and include a composition with monometallic Ag-TOAB and a composition with monometallic Au-TOAB nanoparticles.

FIGS. 2 and 3 show transmission electron microscope (TEM) images of Ag/Au alloy nanoparticles with TOAB ligand prepared according to Example 1 of the invention.

### DETAILED DESCRIPTION OF THE INVENTION

The term “or” as used herein means “and/or” unless specified otherwise.

The term “a” or “an” as used herein means “at least one” unless specified otherwise.

When referring to a moiety (e.g. a compound, an ion, an additive etc.) in singular, the plural is meant to be included. Thus, when referring to a specific moiety, e.g. “compound”, this means “at least one” of that moiety, e.g. “at least one compound”, unless specified otherwise.

A conductive element can be any structure which is electrically conductive, in particular a conductive element may be a conductive image, a conductive layer or a conductive pattern.

The expression “flexible substrate” means a substrate that Taber stiffness measured according to ASTM D5342 or ASTM D5650 below 5,000 Taber stiffness units.

The term “plasma” refers to partially ionized gas (fourth state of matter).

When referring herein to a carboxylic acid or a carboxylate, these terms are meant to include the neutral carboxylic acid, the corresponding carboxylate (its conjugated base) as well as salts thereof.

When referring herein to an amine, this term is meant to include the neutral amine, the corresponding ammonium (its conjugated acid) as well as salts thereof.

When referring herein to an amino acid, this term is meant to include (1) the amino acid in its zwitterionic form (in which the amino group is in the protonated and the carboxylate group in the deprotonated form), (2) the amino acid in which the amino group is in its protonated form and the carboxylic group is in its neutral form and (3) the amino acid in which the amino group is in its neutral form and the carboxylate group is in its deprotonated form as well as salts thereof.

A kit according to the invention may be used to provide a conductive element at room temperature (25° C.). From a preliminary comparison with a commercially available ink (supplied by InkTec), which was sintered at 150° C. to obtain a conductive element, it was concluded that it is feasible in accordance with the invention to provide an element having a conductivity that is similar to that obtained when the commercially available ink is used, without needing a sintering step, and/or without needing to subject the element to a heat treatment.

When applying a kit according to the invention, the ligand does usually not hamper the access of the reagent to the surface of the nanoparticles, or at least not to an unacceptable extent. When applying a kit according to the invention, the ligand does usually not adversely affect the conductivity of the coated layer. Also, applying a kit according to the invention usually does not cause defects in the layer that may detrimentally affect a mechanical property. Without being bound to theory, it is contemplated that during the deposition process, the relatively small ligand according to the invention can dissociate from the nanoparticles much more effectively than large molecules such as polymer molecules.

It has further been found that in accordance with the invention it is possible to provide a dispersion of nanoparticles, having sufficient storage stability for use in the preparation of a conductive element. In a preferred embodiment, it has been found that a dispersion may be provided which does not show any substantial sagging or agglomeration of nanoparticles when inspected with the naked eye and/or analysed with UV-VIS spectroscopy and/or transmission electron microscopy (TEM), after having been stored (protected from light) for at least a month, in particular for at least two months. At least a number of dispersions in accordance with the invention have been found to be storable for at least four months. At least for some dispersions a storage stability of more than a year, e.g. 3-4 years is thought to be feasible. At least for some dispersions, it has been found that these may be stored for several months without being protected from light, and still be useful to provide a dispersion.

Stability of metal nanoparticles can be assessed by visually monitoring the amount of solid deposit upon storage. The smaller the amount of deposit, the higher the stability under the respective conditions. Standard analytical techniques are also suitable to monitor the stability of metal nanoparticles.

UV-VIS measurements can be used to check an increase in size and the degree of aggregation of nanoparticles. A change in size or formation of aggregates generally results in a shift and/or broadening of the characteristic plasmon band. The use of UV-VIS absorption spectroscopy for determining nanoparticle characteristics, in particular for determining a change in size or the degree of aggregation, is described in J. Supramolecular Chemistry, 2002, 305-310 and in references therein.

For the determination of nanoparticle characteristics such as the size, the mean diameter and the size-distribution, TEM can be used. The size, the mean diameter and the size-distribution of the nanoparticles relate to the outer dimensions of the metallic part of the nanoparticle, thus without the inclusion of an eventual ligand. A determination method that makes use of TEM is for example described in EP 1 844 884 A1. A method wherein the particle counting in the TEM analysis process is automated is described in Turk. J. Chem. 30 (2006), 1-13.

A dispersion of metal nanoparticles is considered stable for a certain period, if, after having been stored for that period, it is usable for preparing a conductive pattern.

It is a particular advantage of the invention that a satisfactory or even improved storage stability can be accomplished without needing a polymeric stabiliser or another stabiliser that may need to be removed with the aid of high temperatures in order to improve conductivity of the element.

As indicated above the liquid dispersion A′ comprises dispersed nanoparticles having a metallic surface and a ligand capable of binding to said surface.

The nanoparticles serve as seeds upon which (in the preparation method of the invention) the reduced metal ions are deposited, serve as catalyst for the reduction of the metal ion and/or contribute to the conductivity of the prepared element.

In principle the nanoparticles may be selected from any nanoparticles having a metallic surface. In particular the nanoparticles may be selected from nanoparticles of which at least the surface is made of at least one conductive metal selected from the group of silver, gold, platinum, copper, palladium, nickel, cobalt. The particles may be made of a single material (monolithic) or have a core-shell morphology, wherein the core may for instance be of a material having a different property than the shell. For a high conductivity it is preferred that the core comprises a conductive material, e.g. one or more of said metals. In particular, good results have been achieved with nanoparticles of which at least the surface is of gold, of a gold alloy, of silver, of a silver alloy, or palladium.

In particular, the particles may be selected from gold nanoparticles, silver nanoparticles, gold-silver alloy nanoparticles, and nanoparticles with a core-shell morphology of which the shell is made of gold, silver or a gold-silver alloy. Further examples include nanoparticles in which the alloy and/or core-shell components are selected from copper-silver, copper-gold, copper-palladium, aluminum-silver, aluminum-gold, and aluminum-palladium, respectively.

The presence of an alloy at the surface may in particular be advantageous with respect to improving the stability of the dispersion, compared to a surface of one or the pure metals of the surface. For a dispersion of nanoparticles having a gold-silver alloy surface, an improved storage-stability has been found compared to a dispersion of nanoparticles having a monometallic silver or gold surface. Preferably, the molar ratio Ag:Au in such an embodiment is in the range of 9:1 to 1:9, in particular in the range of 5:1 to 3:1.

The nanoparticles can in principle be of any geometry. For instance nanoparticles may be selected from the group of nano-spheres, nano-ellipsoids, nano-flakes, nano-rods and nano-wires.

In principle, the size of the nanoparticles as determined with TEM can be chosen within wide limits. In general, a nanoparticle according to the invention has at least one dimension that is in the range of 1-1000 nm.

Preferably, at least 90%, in particular at least 95%, more in particular at least 99% of the total volume of the nanoparticles is formed by nanoparticles having at least one dimension that is 100 nm or less, in particular 50 nm or less, more in particular 30 nm or less, even more in particular 20 nm or less, preferably 15 nm or less.

Usually, at least 90%, in particular 95%, more in particular at least 99% of the total volume of the nanoparticles is formed by nanoparticles having at least one dimension that is 1 nm or more, or 2 nm or more.

A relatively small size is advantageous because of the large surface area-to-volume-ratio which increases the surface energy. As a consequence, the reduction rate increases.

The degree of dispersity of a nanoparticle composition is deduced from the standard deviation of the mean size of the nanoparticles. Generally, a composition is considered monodisperse if the standard deviation of the mean size of the nanoparticles is below 20%.

The nanoparticle concentration in the dispersion is usually at least 0.1 wt. % based on total weight of the dispersion. A higher concentration is usually preferred, e.g. for reducing the time needed to prepare a conductive element. Preferably, the nanoparticle concentration in the dispersion is at least 0.5 wt. %. In particular, the nanoparticle concentration in the dispersion may be at least 2 wt. %, more in particular at least 4 wt. % or at least 5 wt. %. The nanoparticle concentration is usually 25 wt. % or less. For a favourable storage stability, easily controllable application of the dispersion (e.g. using ink jets with narrow openings) and/or for facilitating the preparation of a thin element a concentration of 20 wt. % or less is preferred, in particular a concentration of 15 wt. % or less, more in particular of 10 wt. % or less.

As a ligand, in principle any atom, ion or molecule may be used that is capable of bonding to the surface of the nanoparticles, generally involving formal donation of one or more of the ligand's electrons. The ligand is usually chosen such that it binds reversibly to the surface, i.e. that the binding is the result of an equilibrium reaction. The ligand is preferably chosen such that on the one hand it binds sufficiently strong to the surface to stabilise the dispersion of the nanoparticles but on the other hand is relatively easily displaced when the liquid comprising reducible metal ions and/or the liquid comprising the reducing agent are contacted with the dispersion.

In a preferred embodiment a weakly bound ligand is used. Further, in a preferred embodiment a ligand is used that is relatively small, in particular having a molecular weight of less than 1000 g/mol, more in particular of less than 750 g/mol. A relatively small size is considered beneficial in view of making the surface easily accessible to the reducible metal ion and/or reducing agent. Secondly, a relatively small size may lead to an improved dissociation of the ligand during the deposition process, to facilitate deposition of the metal.

Thiols have been reported to bind to metal surfaces. However, it is generally preferred to use a ligand different from thiols, in particular a ligand having a lower affinity for metal surfaces, such as amines, ammonium salts, preferably quaternary ammonium salts, alcohols, and carboxylic acids.

In particular a suitable ligand may be chosen from the group of aliphatic amines, aromatic amines, aliphatic quaternary ammonium compounds, carboxylic acids and amino acids.

An aliphatic amine is preferably selected from amines comprising one or more alkyl groups and/or comprising one or more alkenyl groups. Said groups may in particular have at least 2 or at least 4 carbon atoms. Said groups may in particular have up to 24, up to 20 or up to 18 carbon atoms.

Said groups may be linear or branched. In particular good results have been achieved with 1-amino-9-octadecene (oleyl amine). Other particularly preferred aliphatic amines include hexylamine, octylamine, decylamine and dodecylamine.

Suitable aromatic amines in particular include aromatic amines having a six-membered aromatic ring, more in particular an aminopyridine. In particular a 4-(N,N-dialkylamino)pyridine may be used. Herein each of the alkyls preferably is a C1-C6 alkyl. In particular good results have been achieved with 4-(N,N-dimethylamino)pyridine.

The carboxylic acid may in particular be an aliphatic carboxylic acid. It may be a mono-carboxylic acid or a polycarboxylic acid, such as a dicarboxylic acid or a tricarboxylic acid.

The carboxylic acid usually has up to 24 carbon atoms, preferably up to 20, up to 18 or up to 16 carbon atoms. The carboxylic acid preferably has at least 6 carbon atoms. A carboxylic acid may for example be selected from the group of decanoic, dodecanoic, tetradecanoic, hexadecanoic acid, lactic acid, malic acid, maleic acid, succinic acid and tartaric acid. In particular a polycarboxylic acid such as citric acid, may be used.

The amino acid may be aliphatic or aromatic. Usually, the amino acid has up to 24 carbon atoms, preferably up to 20, up to 18 or up to 12 carbon atoms. The amino acid preferably has at least 3, or at least 4 carbon atoms. In particular, an amino acid may be selected from glutamic acid, aspartic acid, 7-aminoheptanoic acid and 11-aminoundecanoic acid.

A quaternary ammonium compound may in particular be selected from tetra(hydrocarbyl)ammonium compounds. The hydrocarbyls may in particular be selected from alkenyl groups and alkyl groups. The hydrocarbyl groups usually are independently selected from hydrocarbyl groups having 18 carbon atoms or less. Preferably one or more of the hydrocarbyl groups have 12 carbons or less, more preferably 10 carbon atoms or less. One or more of the hydrocarbyl groups preferably are independently selected from hydrocarbyl groups having at least 2, at least 4 or at least 6 carbon atoms. In particular tetraoctylammonium or cetyltrimethylammonium may be used. The quaternary ammonium compound may in particular be a halogenide salt, such as a bromide or chloride salt.

Usually, the ligand content in dispersion A′ is 30 wt. % or less, preferably 25 wt % or less, in particular 15 wt % or less, more in particular 10 wt. % or less, based on the total mass of the nanoparticles.

Usually, the ligand content in dispersion A′ is at least 1 wt. %, in particular at least 2 wt %, more in particular at least 5 wt. %, based on the total mass of the nanoparticles.

Optionally, the dispersion comprises one or more additives, such as one or more additives selected from the group of wetting agents, dyes and pigments. Such additives may be present in a concentration known per se, for conductive ink compositions. The total concentration of such additives in the dispersion is usually 5% wt. % or less, in particular 2% wt. % or less. Herein, it should be noted that if the reducible metal ion is also included in the liquid dispersion, this is not considered to form part of the additives.

In an advantageous embodiment of the invention, the dispersion is essentially free of polymers, that may detrimentally affect a property of the element, such as conductivity. In particular it is preferred that the dispersion is essentially free of gelatine, casein, collagen and albumin, more in particular it is preferred that the dispersion essentially protein-free. In particular it is preferred that the dispersion is essentially free of polyvinyl alcohol, cellulose, cellulose derivatives, polyvinyl pyrrolidone, and polypyrrole, more in particular it is preferred that the dispersion essentially polymer-free. With essentially free of polymers is in particular meant a concentration of less than 0.001 wt. %. If a polymer is present, the total polymer concentration is usually 0.5 wt. % or less, in particular 0.1 wt. % or less, more in particular 0.05 wt. % or less, even more in particular 0.01 wt % or less.

If a polymer is present, this may in particular be a polymer formed by polymerisation of an unsaturated compound (e.g. oleylamine) present in a composition of the invention.

The dispersion further comprises a liquid phase (as a continuous phase). The liquid phase can in principle be any phase wherein the particles can be dispersed. Favourable liquid phases depend to some extent on the type of nanoparticles and/or the ligand used. A suitable liquid can be chosen based on common general knowledge, the information disclosed or the publications referred to herein, and optionally some routine testing. In particular a suitable liquid can be selected from the group of water and organic solvents, including mixtures thereof. One or more organic solvents may in particular be selected from the group of cyclic organic compounds, such as aromatic solvents (toluene), aliphatic cyclic solvents (decaline, cyclohexane), linear or branched alkanes (e.g. a C6-C16 alkane, such as decane or tetradecane) and alcohols (methanol, ethanol, n-propanol, isopropanol, n-butanol, isobutanol).

Preferably, the dispersion is fluid at room temperature (25° C.), more preferably fluid at a temperature of about 15° C.

The concentration of the liquid phase in the dispersion is usually at least 60 wt. %, in particular at least 80 wt. %. The upper limit is determined by the other ingredients, and usually less than 99.9 wt. %, in particular 90 wt. % or less, more in particular 80 wt. % or less.

A liquid B′ comprising reducible silver ions or other reducible metal ions is provided.

Suitable reducible metal ions in addition to silver are known in the art per se, and include inter alia gold ions, platinum ions, copper ions and aluminium ions. The ions are usually provided as a salt or an other compound of the ions. The ions may in particular be of an organic or inorganic salt, partially or fully dissolved, in the liquid. More in particular, the ions may be metal ions of a salt selected from the group of nitrate salts, nitrite salts, carbonate salts, sulfate salts, phosphate salts, chlorate salts, perchlorate salts, fluoride salts, chloride salts, iodide salts, tetrafluoroborate salts, acetate salts, trifluoroacetate salts, pentafluoropropionate salts, lactate salts, citrate salts, oxalate salts, tosylate salts, methanesulfonate salts, and trifluoromethanesulfonate salts. Particularly suitable is a salt selected from the group of nitrate salt and lactate salt.

The concentration of the reducible metal ions may be chosen within wide limits, usually up to the saturation concentration in the liquid (at 25° C.), although in principle an oversaturated solution may be used or a liquid wherein part of the compound providing the ions is not dissolved but, e.g. dispersed in a nanoparticulate form.

In particular the concentration (based on the metal salt or other metal compound providing the ions) may be 80 wt. % or less based on the total weight of the liquid, more in particular 70 wt. % or less, even more in particular 60 wt. % or less. If desired, the concentration may be lower, e.g. less than 40 wt. %. Usually, the concentration (based on the metal salt or other metal compound providing the ions) is at least 10 wt. % based on the total weight of the liquid, preferably at least 20 wt. %, in particular at least 25 wt. % or at least 30 wt. %.

Expressed in terms of moles of metal ion per liter, the metal of the metal salt or metal compound is preferably present in liquid B′ at a concentration of at least 0.4, more preferably at least 0.6, moles/liter up to 4, more preferably up to 3, moles/liter.

The liquid B′ further comprises a solvent for the metal ions. The solvent can in principle be any liquid wherein the metal ions can dissolve and/or be dispersed in a nanoparticulate form. Usually the solvent comprises one or more polar liquids. In particular one or more polar liquids may be present selected from the group of water and water-miscible alcohols, in particular C1-C8 alcohols, such as methanol, n-propanol, iso-propanol, n-butanol, isobutanol, tert-butanol and glycols. If used, it has to be considered that some alcohols, notably ethanol, can form explosive mixtures with silver nitrate, especially in the presence of ammonium hydroxide. The skilled person will know how to select suitable compounds and to reduce the risks involved to an acceptable level.

Preferably, the water concentration is at least 50 wt. % based on total liquids, preferably at least 60 wt. %. The presence of one or more alcohols, in particular in a concentration of about 1-20 wt. %, is advantageous, because it enhances the wettability.

In addition, an alcohol with a high boiling point prevents undesired crystallization processes, because it evaporates slowly. The liquid B′ optionally comprises a crystallization inhibitor such as one or more compounds selected from the group of lactic acid, citric acid, malic acid, malonic acid and glycerol. If present, the concentration of the crystallization inhibitor is usually 0.1 wt % or more, in particular 0.01 wt % or more. In particular, if present the concentration of the crystallization inhibitor is 5 wt. % or less, preferably 2 wt. % or less, more preferably 1 wt. % or less.

Liquid B′ is usually fluid at 25° C., and preferably at 15° C.

In the kit, the liquid C′ comprising the reducing agent is typically present in a container which is not in fluid communication with liquid B′ nor with liquid A′, prior to use, in order to avoid premature reaction of the reducing agent with the reducible metal salt and/or the nanoparticles.

In principle, any reducing agent that can be used to reduce metal ions to zerovalent metal is a suitable reducing agent. Suitable reducing agents may be chosen based on commonly known redox-couples to reduce the metal salt to zero-valency. For instance, a reducing agent may be used, as mentioned in a publication referred to herein above. In particular, a reducing agent may be present selected from the group of ascorbic acid, mineral ascorbates, optionally substituted hydroquinones, optionally substituted amino phenols, phenylenediamine, phenidone, hydrazine, alkyl hydrazines, aryl hydrazines, borohydrides (such as sodium borohydride, potassium borohydride, zinc borohydride, sodium cyanoborohydride), dimethylaminoborane, diborane, lithium aluminum hydride, hydroxylamine, hypophosphorous acid, polyols such as ethylene glycol, glucose and other reducing sugars, citric acid, N,N-dimethylformamide, formic acid, glyoxylic acid, aldehydes such as formaldehyde, glyoxal and glyceraldehyde, and cyclic aldehyde oligomers such as trioxane, glycolaldehyde dimer and glyoxal trimeric dehydrate.

The reducing agent concentration is usually at least 5 wt. %, based on the total weight of the liquid, preferably at least 10 wt. %. The concentration is usually 40 wt. % or less, preferably 25 wt. % or less.

The size and shape of the nanoparticles can be influenced by the amount of reducing agent that is used. It appears for example that more reducing agent generally results in smaller nanoparticles.

The liquid C′ further comprises a solvent for the reducing agent. The solvent can in principle be any liquid wherein the reducing agent can dissolve. Usually the solvent comprises one or more polar liquids. In particular one or more one or more polar liquids may be present selected from the group of water and water-miscible alcohols, such as methanol, ethanol, n-propanol, iso-propanol, glycols. Preferably, the water concentration is at least 50 wt. % based on total liquids, preferably at least 75 wt. %, in particular at least 80 wt. %. The presence of one or more alcohols, in particular in a total alcohol concentration of about 5-20 wt. %, is advantageous for good wettability and spreading on the already deposited pattern containing the metal nanoparticles and/or reducible metal.

The liquid C′ may also comprise a stabilizer such as sodium sulfite or boric acid. Preferably, the concentration of the stabilizer is 3% or less, more preferably it is 1% or less.

Further, one or more amines may be present in the liquid C′, which is considered to be advantageous for a faster or more efficient reduction process. The amine may in particular be selected from the group of alkanolamines, e.g. ethanolamine, and alkylamines, e.g. n-pentylamine. If present, the concentration is usually about 0.1-5 wt. %, in particular 0.2-3 wt. %.

Liquid C′ is usually fluid at 25° C., and preferably at 15° C.

As indicated above, the invention further relates to a method for preparing a conductive element.

Advantageously, a method of the invention can be carried out at a relatively low temperature, if desired. Usually, a method of the invention may be carried out at a temperature of less than 100° C. A method of the invention is in particular suitable for preparing a conductive element at a temperature below 50° C., more in particular at 40° C. or less, or 30° C. or less. In practice, the preparation usually takes place at a temperature of 5° C. or more, in particular of 10° C. or more, or 20° C. or more. Thus, the method may very suitably be carried out under ambient conditions (temperature generally in the range of 15-30° C.), without needing to heat any of the liquids separately prior to application, or to sinter the substrate to which the liquids have been applied to form the conductive element.

The method can be carried out within a broad pressure range. The pressure is preferably at least 0.5, more preferably at least 0.8, kPa up to 5, more preferably up to 2, kPa. Typically, the method is carried out at ambient pressure (e.g., 1 kPa).

The liquids can be applied simultaneously or sequentially. For improved conductivity, it is preferred to apply liquid dispersion A′ before liquid C′ comprising the reducing agent.

In a particularly preferred method first the liquid dispersion A′ is applied, thereafter the liquid C′ comprising the reducing agent, and thereafter the liquid B′ comprising the reducible metal salt.

The liquids may in particular be applied by printing, more in particular by ink jet printing or spraying. In a preferred embodiment, the method comprises applying the liquid dispersion A′, the liquid B′ and the liquid C′ to a substrate by ink jet printing or spraying the respective liquids so that the respective liquids are brought into contact with each other, such as by ink jet printing or spraying each liquid in a pattern on a substrate that substantially overlaps and/or coincides with the pattern applied with the other two components. For this purpose, the liquid dispersion A′, liquid B′ and liquid C′ are preferably provided in separate ink jet cartridges. The ink jet cartridges are preferably installed in an ink jet printer. The ink jet printer is preferably controlled by a suitable programmed electronic device, such as a computer.

The resulting conductive pattern may optionally be treated with electromagnetic radiation or plasma to increase the conductivity of the pattern. Examples of suitable electromagnetic radiation include ultraviolet light (UV), visible light, infrared (IR) radiation, microwave radiation, and electron beam radiation. The electromagnetic radiation is preferably applied at an irradiance of at least 500, more preferably at least 1,000, even more preferably at least 1,500, Watts/m²

Plasmas are preferably non-thermal. Suitable plasmas comprise partially ionized air with or without helium or argon stabilization. The plasma may be generated by various means, such as corona discharge, dielectric barrier discharge or capacitive discharge.

The invention provides various kits for preparing a conductive element, providing kits for various substrates, including hydrophobic substrates and hydrophilic substrates. For instance, a system comprising a (n aqueous) dispersion comprising nanoparticles comprising silver and/or gold and/or silver alloy and/or gold alloy and/or silver-gold alloy that are stabilized with an aminopyridine or with an amino acid or a functionalized carboxylic acid having at least two carboxylic acid groups (e.g. aspartic acid and citrate), may be in particular suitable for providing a hydrophilic substrate with a conductive element without needing surface pre-treatment. A system comprising nanoparticles of which the surface has a gold-silver alloy surface, stabilised with an ammonium compound such as tetraoctylammonium or a system comprising a gold or silver surface, stabilised with an alkenyl amine such as oleyl amine may be particularly suitable for preparing a conductive element on a hydrophilic substrate or a hydrophobic substrate, without needing to pre-treat the surface of the substrate.

The invention is suitable not only to provide a conductive element to a rigid substrate but also to a flexible substrate, e.g. in the manufacture of devices comprising flexible, or even rollable, electronics, such as flexible or rollable computers, displays, lighting surfaces, thin-film solar cells, and sensors and integrated devices that can be incorporated into biological tissues.

The flexible substrate preferably has a Taber stiffness measured according to ASTM D5342 or ASTM D5650 below 500 Taber stiffness units, and even more preferably below 50 Taber stiffness units. The flexible substrate preferably has a stiffness of at least 1 Taber stiffness unit, more preferably at least 5 Taber stiffness units.

The substrate on which the element is prepared may in particular be selected from the group of substrates comprising a paper surface, a plastic surface, a ceramic surface, a glass surface, a silicon surface, a metal surface, a metal oxide surface, or comprising a surface that comprises a combination of two or more of these surfaces.

Specific plastics that may advantageously be provided with a conductive element include in particular substrates selected from the group of substrates comprising a polyalkylene naphtalate surface (e.g. a polyethylene naphtalate surface), a polyalkylene terephtalate surface (e.g. a polyethylene terephtalate surface), a polyimide surface, a polyimine surface, a polyvinyl chloride surface or comprising a surface that comprises a combination of two or more of these surfaces.

Advantageously, the substrate may be a material that is not able to withstand the high temperatures used for thermal sintering of state of the art metal nanoparticles-based inks to form a conductive pattern or layer. In particular, the substrate may have a melting point and/or thermal combustion in air temperature below 600° C., such as below 300° C. or even below 200° C. The substrate melting point and/or thermal combustion in air temperature is preferably greater than 50° C.

A method of the invention may in principle be used to prepare any kind of product comprising a (metallic) conductive element.

In particular, a method of the invention may be used to prepare a product selected from the group of electronic devices. In particular, the device may be selected from the group of circuit boards, solar cells, radio frequency identification (RFID) tags, RFID antennas, LED's, particularly OLEDs, LCD's, conductive arrays, shunt lines and bus bars such as those in LEDs and LCDs, and photovoltaic cells (e.g., interconnects for monolithic cell modules). More in particular, a method of the invention may be used to prepare an electrically conductive connection between individual contacts of electronic components.

The invention will now be illustrated by the following examples.

### Example 1

### Alloy Ag/Au TOAB Nanoparticles

Alloy Ag/Au TOAB nanoparticles were prepared using an adaptation of the Brust procedure (Brust, M.; Schiffrin, D. J., J. Chem. Soc. Chem. Commun. 1994, 801-807). 0.1 mmol (40 mg) hydrogen tetrachloroaurate (III) trihydrate (HAuCl₄×3H₂O) was dissolved in 10 mL water. 0.4 mmol (68 mg) of silver nitrate was added to yield an orange-brownish suspension. A solution of tetraoctylammonium bromide (TOAB) (1 mmol; 547 mg) in 5 mL of toluene was added to the above aqueous suspension. Within few minutes the organic layer turned orange-brownish while the aqueous layer turned clear colorless. The mixture was stirred for 15 minutes, and then a freshly prepared solution of sodium borohydride (5 mmol (190 mg) in 1 mL water) was added dropwise under vigorous stirring. The organic layer became dark-brown with a silver-like shine at the interface. The mixture was stirred overnight at room temperature. The clear reddish-brown organic layer was isolated and washed with water several times. Upon solvent removal a reddish-black solid was obtained. The solid was readily soluble in toluene and mixtures of toluene:acetone. A higher degree of purity could be achieved by precipitation with ethanol from a toluene:acetone 1:1 solution. Repeated precipitation or extensive washings with ethanol lead to less soluble nanoparticles as the result of removal of the protecting TOAB below the stabilization threshold.

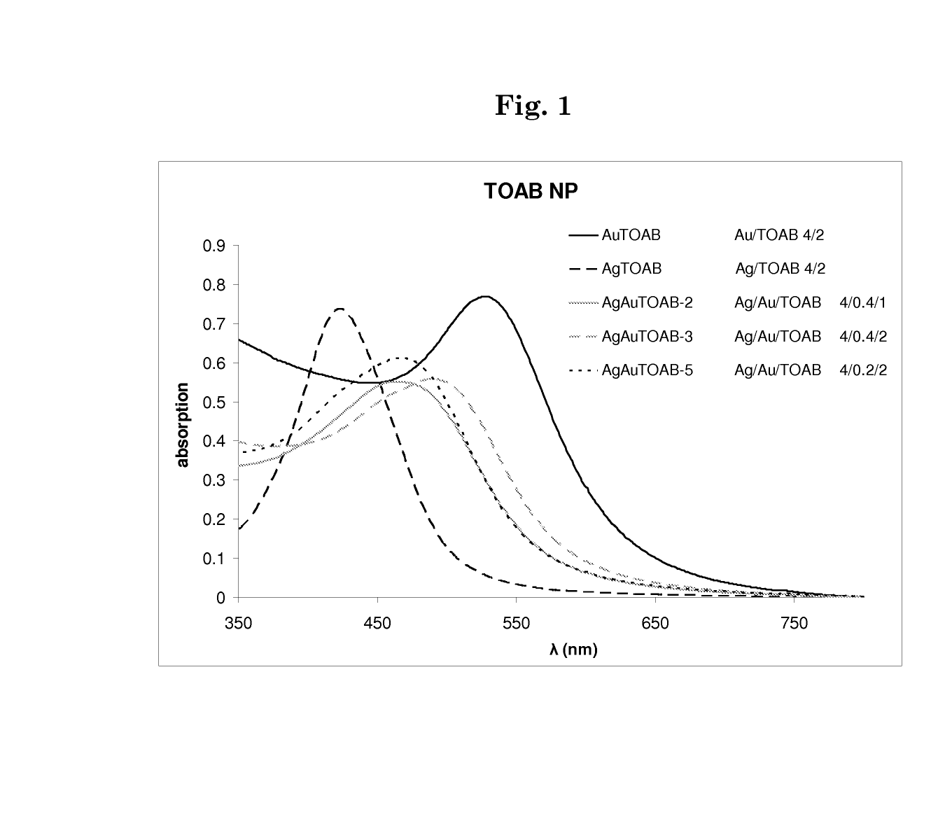

The UV-VIS spectrum in toluene showed a single plasmon band located at 478 nm, which is consistent with formation of bi-metallic alloy nanoparticles. A core-shell arrangement would give rise to two surface plasmon absorption bands, whose intensities depend on the initial composition of the metal ions. If separate gold and silver nanoparticles would have formed instead of the homogeneous alloy particles a similar two band spectra would have been also obtained. The two bands would be located either between 410 and 420 nm, which is characteristic for silver nanoparticles or between 510 and 530 nm, which is typical for the gold nanoparticles. The spectrum of Ag/Au TOAB nanoparticles depicted in FIG. 1 shows only a single absorption band with the absorption maxima between those for pure gold and silver nanoparticles.

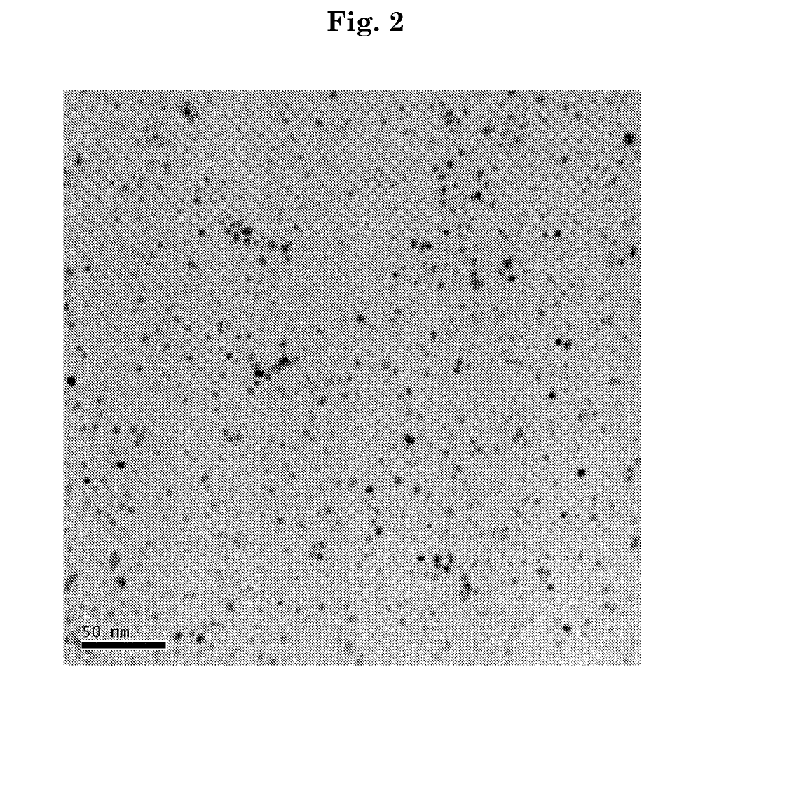

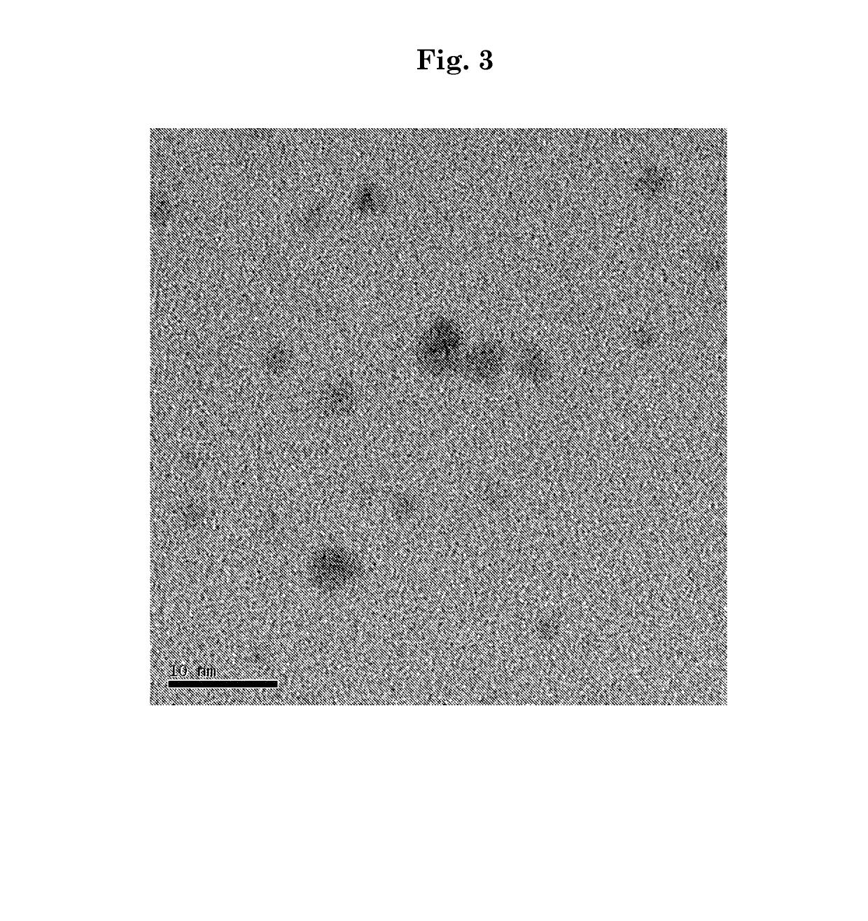

The mean diameter and the size distribution appeared to depend on the concentration of the solutions comprising gold and silver, as well as on the ratio of metal (Ag and Au):TOAB. It generally lies between 2-10 nm. For example, when a ratio Au:Ag:TOAB:NABH₄ of 0.5:1:2:10 (mol:mol:mol:mol) was used, the mean diameter of the alloy nanoparticles as measured by TEM is 2.5 nm (the minimum diameter being 1.4 nm; the maximum diameter being 7.3 nm; the standard deviation being 1.0 nm). FIG. 2 and FIG. 3 are TEM images of the obtained nanoparticles.

Various Ag:Au ratios can be used to prepare alloy nanoparticles. However, a certain amount of gold is required in order to form stable alloy nanoparticles. If a lesser amount of gold is used (ratio Ag:Au lower than 9:2) the yield dramatically decreases and the non-alloyed silver would aggregate and precipitate. This material is insoluble and cannot be redispersed anymore in organic and/or aqueous solvents.

Silver and gold monometallic nanoparticles were also prepared following the same procedure. The silver nanoparticles appeared stable for several hours or days (even when a ratio of Ag:TOAB 1:5 was used). Gold nanoparticles appeared to be more stable than silver nanoparticles: 3-4 weeks (protected from light) or 1-2 weeks (unprotected from light). Remarkably, the alloy Ag/Au nanoparticles were stable during periods exceeding 4 months under ambient conditions, even when unprotected from light.

### Example 2

### 11-Aminoundecanoic Gold Nanoparticles

1.27 mmol (0.5 g) hydrogen tetrachloroaurate (III) trihydrate (HAuCl₄×3H₂O) was dissolved in 50 mL water yielding a clear yellow solution. 1.27 mmol (0.7 g) tetraoctylammonium bromide (TOAB) was dissolved in toluene (50 mL) yielding a clear colorless solution. The TOAB solution in toluene was then added to the aqueous gold solution and stirred for 15 min to realize phase transfer of the gold salt to the organic layer. When the phase-transfer process had reached completion the organic layer had a dark-orange color while the aqueous phase was clear colorless. To this two-phase mixture a freshly prepared solution of sodium borohydride (12.7 mmol; 0.48 g in 4 mL water) was added dropwise. The mixture gradually turned dark-brown, then dark-red. The mixture was stirred overnight at room temperature. Then the clear dark-red organic phase containing Au-TOAB nanoparticles was isolated and washed with water several times in order to remove water-soluble by-products as well as the excess of TOAB. An exchange reaction with 11-aminoundecanoic acid was performed as follows: 3.5 mmol (0.755 g) of 11-aminoundecanoic acid were added to the toluene solution containing the Au-TOAB nanoparticles. The mixture was allowed to stand at room temperature overnight for the exchange reaction to take place. Hereafter, the solvent was evaporated under mild conditions and the solid residue was washed copiously with water and then redispersed in ethanol. A mixture of ethanol/toluene (10:90 to 90:10) could be used instead of pure ethanol. The gold nanoparticles capped with 11-aminoundecanoic acid were stable in alcohol solutions for several months.

### Example 3

### 4-(N,N-dimethylamino)pyridine Gold Nanoparticles

The gold nanoparticles were prepared using an adaptation of the procedure reported by Gittins et al. (Gittins, D. I.; Caruso, F., Angew. Chemie 2001, 40, 3001-3004). The 4-(N,N-dimethylamino)pyridine gold nanoparticles were prepared using pre-formed gold nanoparticles stabilized with TOAB by a ligand-exchange reaction as described for 11-aminoundecanoic gold nanoparticles in EXAMPLE 2. To 50 mL of TOAB-Au nanoparticles in toluene 3.5 mmol (0.428 g) of 4-(N,N-dimethylamino)pyridine (DMAP) was added. The solution turned bluish and precipitate started to form. The mixture was allowed to stand at room temperature for several hours until all the nanoparticles had precipitated and a clear colorless solution remained. The precipitate was separated by centrifugation washed with toluene (2×50 mL) in order to remove the excess DMAP and residual TOAB. The purified DMAP-Au nanoparticles were readily and completely dispersed in water yielding a deep-red clear dispersion. Extensive washings with toluene need to be avoided as DMAP can be easily washed away, which leads to nanoparticles aggregation and the formation of insoluble material. The aqueous dispersion of DMAP-gold nanoparticles can be stored under ambient conditions protected from light for 3-4 years.

### Example 4

### Aspartic Acid Gold Nanoparticles

The gold nanoparticles were prepared using an adaptation of the procedure reported by Mandal et al. (Mandal, S.; Selvakannan, P.; Phadtae, S.; Pasricha, R.; Sastry, M., Proc. Indian Acad. Sci. (Chem. Sci.) 2002, 114, 513-520). 0.01 mmol (3.4 mg) hydrogen tetrachloroaurate (III) trihydrate (HAuCl₄×3H₂O) were dissolved in 1 mL water and added to a boiling solution of aspartic acid (0.03 mmol; 40 mg) in 30 mL of water. The resulting dispersion of aspartic acid gold nanoparticles was red. The dispersion is stable under ambient conditions (protected from light) for several months.

### Example 5

### Citrate Gold Nanoparticles

The gold nanoparticles were prepared using an adaptation of the procedure reported by Turkevich et al. (Turkevich, J.; Stevenson, P. C.; Hillier, J., Discuss. Faraday Soc. 1951, 11, 55-56). 0.02 mmol (6.8 mg) hydrogen tetrachloroaurate(III) trihydrate (HAuCl₄×3H₂O) were dissolved in 20 mL of water and brought to ebullition. To this solution an aqueous solution (30 mL) of trisodium citrate (0.03 mmol) was added and the mixture was refluxed for 30 min. The resulting dispersion of citrate gold nanoparticles was deep red. The dispersion is stable under ambient conditions (protected from light) for 1-2 years.

### Example 6

### Oleylamine-Stabilized Silver Nanoparticles

2.5 mmol (0.6 g) of silver heptanoate and 0.5 mL of oleylamine were dissolved in toluene (25 mL). To the viscous (gel-like) solution were added 10 drops of ascorbic acid solution (20% in water) under vigorous stirring. The mixture stirred for 3 hours, after which the silver nanoparticles were precipitated with a mixture of acetone/ethanol 1/1. The precipitate was isolated and dried to yield a dark-brown powder of silver nanoparticles.

### Example 7

### Preparing a Conductive Pattern

A conductive pattern was prepared with a kit according to the invention. Dispersion A′ comprised a dispersion of 3 g of gold oleylamine nanoparticles in 100 mL of toluene/decaline 7/3 (vol/vol). Liquid B′ was a solution of 60 g of silver nitrate in 100 mL of a mixture of water/isopropanol/ethanol 7/2/1 (vol/vol/vol). Liquid C′ comprised a mixture of 10 g of ascorbic acid and of 1 mL of ethanolamine in 100 mL of a mixture of water/isopropanol/8/2 (vol/vol). First, the gold nanoparticles (dispersion A′) were deposited on PEN foil (polyethylene naphtalate, supplied by AGFA). Secondly, liquid C was deposited, and finally liquid B′ was deposited. The deposited lines were conductive, had a mirror-like metallic shine on the bottom side (contact with the foil) and were white-grey on the top side. An optional washing step with water can be performed in order to remove excess/unreacted products.

1. Kit for preparing a conductive element comprising
a container A containing a liquid dispersion A′, comprising dispersed nanoparticles having a metallic surface and a ligand capable of binding to said surface;
a container B—which may be the same or different as the container A containing the liquid dispersion A′—said container B containing a liquid B′ comprising reducible silver ions or other reducible metal ions; and
a further container C containing a liquid C′ comprising a reducing agent for the metal ions of the liquid from container B.

2. Kit according to claim 1, wherein at least 90% of the total volume of the nanoparticles is formed by nanoparticles having at least one dimension of 1-100 nm, preferably of 1-30 nm.

3. Kit according to claim 1 or 2, wherein the concentration of nanoparticles in the liquid dispersion is at least 0.1 wt. %, based on total weight of the dispersion, in particular 0.5-25 wt. %, more in particular 2-20 wt. % or 5-15 wt. %.

4. Kit according to any one of the preceding claims, wherein a least one ligand is present selected from the group of aliphatic amines, aromatic amines, aliphatic quaternary ammonium compounds, carboxylic acids and amino acids,
in particular from the group of aliphatic amines comprising one or more alkyl groups, each alkyl group having 1-18 carbon atoms; aliphatic amines comprising one or more alkene groups having 2-18 carbon atoms; C₃-C₁₈ aliphatic monocarboxylic acids; aliphatic polycarboxylic acids comprising up to 20 carbon atoms; C₁-C₁₈ aliphatic amino acids; amino pyridines, wherein to the amino group of the pyridine one or two C₁-C₆ alkyl groups may be attached; tetraalkyl ammonium compounds, wherein each of the alkyl groups is independently selected from C₁-C₁₈ alkyls,
and more in particular from the group of glutamic acid, aspartic acid, 7-aminoheptanoic acid, 11-aminoundecanoic acid, citric acid, 4-(N,N-dimethylamino)pyridine, 1-amino-9-octadecene, lactic acid, malic acid, maleic acid, succinic acid and tartaric acid.

5. Kit according to any of the preceding claims, wherein the ligand content is in the range of 5 to 30 wt. %, preferably in the range of 5 to 15 wt. %, based on the total mass of the nanoparticles.

6. Kit according to any of the preceding claims, wherein the particles are selected from the group of gold nanoparticles, silver nanoparticles, gold-silver alloy nanoparticles, copper-silver alloy nanoparticles, copper-gold alloy nanoparticles, copper-palladium alloy nanoparticles, aluminum-silver alloy nanoparticles, aluminum-gold alloy nanoparticles, and aluminum-palladium alloy nanoparticles and nanoparticles with a core-shell morphology of which the shell is made of gold, silver, gold-silver alloy, or palladium.

7. Kit according to any of the preceding claims, wherein the reducible metal ions are of a salt selected from the group of nitrate salts, nitrite salts, carbonate salts, sulfate salts, phosphate salts, chlorate salts, perchlorate salts, fluoride salts, chloride salts, iodide salts, tetrafluoroborate salts, acetate salts, trifluoroacetate salts, pentafluoropropionate salts, lactate salts, citrate salts, oxalate salts, tosylate salts, methanesulfonate salts, and trifluoromethanesulfonate salts.

8. Kit according to any of the preceding claims, wherein the reducible metal ions are of a metal salt, and the concentration of said salt in the liquid is between 20-80 wt. % based on the total weight of the liquid, in particular 25-70 wt. %, more in particular 30-60 wt. %.

9. Kit according to any of the preceding claims, wherein the reducing agent is present in a concentration of 5-25 wt. % based on the liquid comprising the reducing agent.

10. Kit according to any of the preceding claims, wherein the liquid dispersion A′, the liquid B′ comprising the reducible metal salt and the liquid C′ comprising the reducing agent are fluid at 25° C.

11. Nanoparticles comprising a silver alloy or a gold alloy, in particular an alloy of gold and silver, of which particles the surfaces have been provided with a ligand selected from the group of quaternary ammonium compounds.

12. Method for preparing a conductive element, comprising applying
a liquid dispersion A′, comprising dispersed nanoparticles having a metallic surface to which surface a ligand is bound;
a liquid B′ comprising a reducible silver ion or another reducible metal ion; and
a liquid C′ comprising a reducing agent for the metal ions;
to a substrate and reducing the reducible salt, under formation of the conductive element.

13. Method according to claim 12, wherein at least one of the liquid dispersion A′, the liquid B′ comprising the reducible metal salt and the liquid C′ comprising the reducing agent are as defined in any of the claims 2 to 11.

14. Method according to claim 12 or 13, wherein the application and the reduction are carried out at a temperature below 100° C., preferably at a temperature in the range of 5-40° C., more in particular at a temperature in the range of 10-30° C.

15. Method according to any one of claims 12 to 14, further comprising treating the resulting conductive element with electromagnetic radiation or plasma to increase the conductivity of the conductive element.

16. Product comprising a conductive element obtainable by a method according to any one of claims 12 to 15.
